(19) United States
(12) Patent Application Publication
(10) Pub. No.: US 2009/0024465 A1
(43) Pub. Date: Jan. 22, 2009

(54) ADAPTIVE ADVERTISEMENT PLACEMENT RESPONSIVE TO SEARCH TERMS

(75) Inventors: Erik J. Burckart, Raleigh, NC (US); Andrew J. Ivory, Wake Forest, NC (US); Todd E. Kaplinger, Raleigh, NC (US); Aaron K. Shook, Morrisville, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/780,878

(22) Filed: Jul. 20, 2007

(51) Int. Cl. G06Q 30/00; G06F 17/30

(52) U.S. Cl. 705/14

(57) ABSTRACT

Embodiments of the present invention address deficiencies of the art in respect to search engine ad placement and provide a method, system and computer program product for adaptive ad placement responsive to search terms. In one embodiment of the invention, a method for adaptive ad selection can be provided. The method can include placing both an ad and a search component within a page, auto-completing a search fragment for the search component with a keyword list, matching the keyword list to a new ad, and inserting the new ad into the page. In this regard, placing the ad within the page can include placing a default ad for the page within the page to be replaced by the new ad responsive to the auto-completion of the search component.

### BACKGROUND OF THE INVENTION

1. Field of the Invention

The present invention relates to the field of Internet advertising and more particularly to search engine ad placements.

2. Description of the Related Art

The Internet has revolutionized the manner in which goods and services are marketed both locally and globally. The mere collection of a few electronic documents can represent a complex storefront when presented to the global computing community over the World Wide Web as a Web site. Interestingly, unlike the conventional sale of goods and services through a brick-and-mortar operation, the pages of a Web site can serve the purpose both of advertising and marketing medium and storefront. To with, the content of a Web page can serve as a way to advertise goods and services, while also offering those same goods and services for sale responsive to a few mouse clicks.

Given the unique role of the Internet in the sale and marketing of goods and services, fundamental changes in traditional advertising and marketing have become apparent. In particular, e-marketing, unlike traditional marketing, involves a grass roots component. Search engines have facilitated the development of this grass roots component in which consumers discover the presence of a Web site through the postings of third parties. In the search engine paradigm, references to Web sites are cataloged and presented to consumers on demand in response to keyword searches.

The sheer volume of content indexed by the typical search engine can result in the individual Web sites becoming lost in the mix. Similar to a phone book entry among a sea of phone book entries, for many Web sites, the indexing of the Web site by the search engine can be as ineffective as not being indexed at all unless the Web site appears in the first few entries of a results list produced by the search engine. Accordingly, many Web sites rely on more advanced, fee-based, Internet based grass roots marketing techniques to advance the awareness of a Web site. A traditional fee-based approach is to sell ad placements within a search page wherein the ads presented adjacent to search results depend directly from the keywords searched in producing the search results.

Oftentimes, end users lack a clear understanding of what type of results will flow from providing a particular search term or set of search terms. In consequence, end users engage in searches on an ad hoc basis, providing search terms, viewing multiple pages of results, and refining the search terms seeking different pages of results. The number of user interface actions required on the part of the end user then, can be less than optimal. In this regard, many search terms are likely not to correspond to search results in as much as only a discrete vocabulary of search terms can be supported by many search engines--especially those search engines configured to relate to a compact set of pages like those encountered in an electronic storefront.

To assist the end user in searching a storefront, auto-completion technologies have proven helpful. Auto-completion technologies recognize character entries provided by an end user in a search field and dynamically provide suggested search terms likely to produce search results. For example, for a search engine able to produce search results for the terms “apple”, “apricot”, “Atlanta” and “assailant”, the initial entry of “a” will produce a listing in a pop-up box of all four terms, however, as the user types “p” following the “a”, the list in the pop-up box can be reduced only to “apple” and “apricot”. In this way, the user is spared the prospect of guessing as to which terms will likely produce a reasonable results.

### BRIEF SUMMARY OF THE INVENTION

Embodiments of the present invention address deficiencies of the art in respect to search engine ad placement and provide a novel and non-obvious method, system and computer program product for adaptive ad placement responsive to search terms. In one embodiment of the invention, a method for adaptive ad selection can be provided. The method can include placing both an ad and a search component within a page, auto-completing a search fragment for the search component with a keyword list, matching the keyword list to a new ad, and inserting the new ad into the page. In this regard, placing the ad within the page can include placing a default ad for the page within the page to be replaced by the new ad responsive to the auto-completion of the search component.

In another embodiment of the invention, a content distribution system can be provided. The system can include a keyword service executing in a server coupled to a site server and configured to provide a keyword list in response to receiving a search fragment in an auto-completion process for a search component of a page served by the site server. The system further can include ad selection logic executing in a server coupled to the site server. The logic can include program code enabled to match an ad to the keyword list for placement in the page. In one aspect of the embodiment, the auto-completion process can include an asynchronous JavaScript extensible markup language (AJAX) exchange of the search fragment for the keyword list between the search component of the page and the keyword service.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a content driven site configured for adaptive ad placement responsive to search terms;

FIG. 2 is a schematic illustration of a content distribution system configured for adaptive ad placement responsive to search terms; and,

FIG. 3 is a flow chart illustrating a process for adaptive ad placement responsive to search terms.

### DETAILED DESCRIPTION OF THE INVENTION

Embodiments of the present invention provide a method, system and computer program product for adaptive ad placement responsive to search terms. In accordance with an embodiment of the present invention, a site page for a content site can be rendered along with a search component enabled to search the site according to provided search terms. Auto-completion logic can be coupled to the search component and can generate a keyword list based upon a provided search term fragment in the search component. In response to the generation of the keyword list, the keyword list can be matched to a data store of ads and an ad matching the keyword list can be identified and placed within the site page. In this way, the content of the ad can adapt to the keyword list generated relative to the progressive input of a search term fragment in the search component.

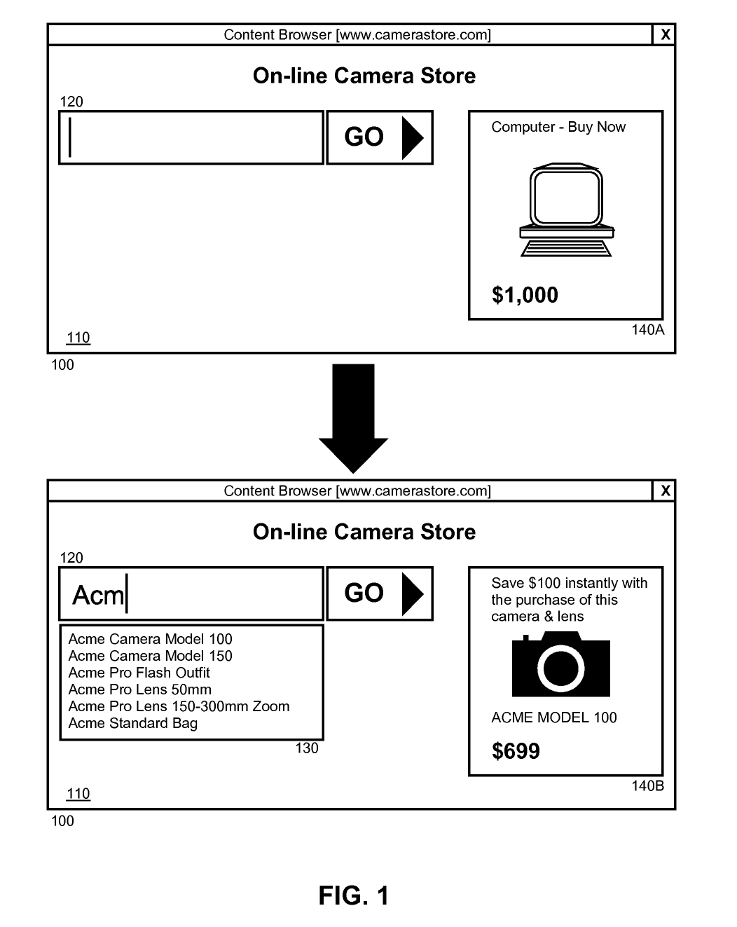

In illustration, FIG. 1 is a pictorial illustration of a content driven site configured for adaptive ad placement responsive to search terms. As shown in FIG. 1, a content page 110 can be provided for a content site and rendered within a content browser 100. The content page 110 can include both a search component 120 and an ad placement 140A. Initially, a default ad placement 140A can be selected for inclusion in the content page 110 as a default selection. As a search term fragment is input in the search component 120, a keyword list 130 can be generated through auto-completion for the search term fragment. In turn, the default ad placement 140A can be replaced with an adaptive ad placement 140B specific to the keyword list 130 generated by the search term fragment in the search component 120.

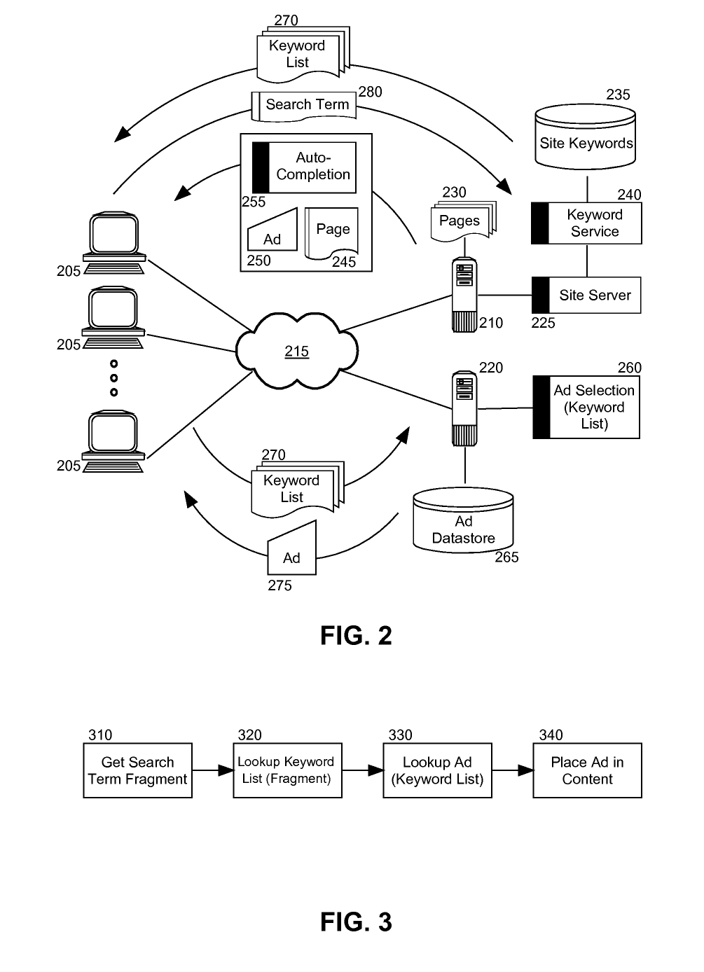

The content driven site can be served within a content distribution system. In this regard, FIG. 2 is a schematic illustration of a content distribution system configured for adaptive ad placement responsive to search terms. The system can include a content distribution host 210 configured for communicative coupling to one or more content consumers 205 over a computer communications network 215. The content distribution host 210 can support the operation of a site server 225 programmed to serve requested pages 230 to requesting ones of the content consumers 205 to be rendered within respective content browsers. Additionally, a keyword service 240 can be communicatively coupled to the site server 225 and enabled to respond to search term fragments to produce a subset of site keywords 235 as part of an auto-completion function distributed with selected ones of the pages 230.

Specifically, the site server 225 can include program code enabled to respond to content requests from individual ones of the content consumers 205 for content. The response can include a page 245 along with a default ad 250. Auto-completion logic 255 further can be served with the page 245. The auto-completion logic 255 can include program code enabled to detect a search term fragment 280 provided within a search component of the page 245 and to obtain in response to the search term fragment 280, a keyword list 270 extending from a search term fragment 280. The keyword service 240 can be integral to this process by selecting the keyword list 270 from amongst the site keywords 235 in response to the search term fragment 280.

An ad server 220 further can be communicatively coupled to the content consumers 205 over the computer communications network. Specifically, the ad server 220 can be coupled to an ad data store 265 of advertisements for inclusion in pages 230 served to the content consumers 205. Notably, ad selection logic 260 yet further can be coupled to the ad server 220. The ad selection logic 260 can include program code enabled to match a provided keyword list 270 with ads in the ad data store 265 in order to select an ad 275 contextually related to the keyword list 270. The selected ad 275 in turn can be provided to a requesting one of the content consumers 205 for rendering in connection with a received one of the pages 230 provided by the site server 225. In this way, the presentation of the ad 275 can adapt to the keyword list 270 generated as part of the operation of the auto-completion logic 255 for the search term fragment 280.

In yet further illustration, FIG. 3 depicts a process for adaptive ad placement responsive to search terms to be performed in the system of FIG. 2. Beginning in block 310, a search term fragment can be obtained as part of an auto-completion process for a corresponding search component in a page. The auto-completion process can be implemented according to AJAX in which JavaScript logic can retrieve the input search fragment and can communicate directly with the keyword service using the JavaScript XMLHttpRequest object. With this object, the JavaScript logic can trade data with the keyword service, including a returned keyword list, without reloading the page.

In block 320, a keyword list can be selected for the search term fragment and the keyword list can be rendered in connection with the auto-completion process of a corresponding search component. In block 330, an ad can be matched to the keyword list and selected as being relevant to the keyword list. Again, AJAX technology can be applied in providing the keyword list to ad selection logic in order to retrieve a matched ad for the keyword list. Finally, in block 340, the matched ad can be placed in the page so as to produce an adaptive ad placement responsive to search terms presented in the page.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for adaptive ad selection comprising:
placing both an ad and a search component within a page;
auto-completing a search fragment for the search component with a keyword list;
matching the keyword list to a new ad; and,
inserting the new ad into the page.

2. The method of claim 1, wherein placing the ad within the page, comprises placing a default ad for the page within the page.

3. The method of claim 1, wherein auto-completing a search fragment for the search component with a keyword list, comprises executing an asynchronous JavaScript extensible markup language (AJAX) exchange of the search fragment for the keyword list with a remotely disposed keyword service.

4. The method of claim 3, wherein matching the keyword list to a new ad, comprises executing an AJAX exchange of the keyword list for the new ad with remotely disposed ad selection logic.

5. A content distribution system comprising:
a keyword service executing in a server coupled to a site server and configured to provide a keyword list in response to receiving a search fragment in an auto-completion process for a search component of a page served by the site server; and,
ad selection logic executing in a server coupled to the site server, the logic comprising program code enabled to match an ad to the keyword list for placement in the page.

6. The system of claim 5, wherein the auto-completion process comprises an asynchronous JavaScript extensible markup language (AJAX) exchange of the search fragment for the keyword list between the search component of the page and the keyword service.

7. A computer program product comprising a computer usable medium embodying computer usable program code for adaptive ad selection, the computer program product comprising:
computer usable program code for placing both an ad and a search component within a page;
computer usable program code for auto-completing a search fragment for the search component with a keyword list;
computer usable program code for matching the keyword list to a new ad; and, computer usable program code for inserting the new ad into the page.

8. The computer program product of claim 7, wherein the computer usable program code for placing the ad within the page, comprises computer usable program code for placing a default ad for the page within the page.

9. The computer program product of claim 7, wherein the computer usable program code for auto-completing a search fragment for the search component with a keyword list, comprises computer usable program code for executing an asynchronous JavaScript extensible markup language (AJAX) exchange of the search fragment for the keyword list with a remotely disposed keyword service.

10. The computer program product of claim 9, wherein the computer usable program code for matching the keyword list to a new ad, comprises computer usable program code for executing an AJAX exchange of the keyword list for the new ad with remotely disposed ad selection logic.
